(19) United States
(12) Patent Application Publication
(10) Pub. No.: US 2025/0290364 A1
(43) Pub. Date: Sep. 18, 2025

(54) COMPONENT BASED FRAME AND FLEXIBLE SHEET SYSTEM FOR A LARGE OPENING

(71) Applicant: MARHAYGUE, LLC, Georgetown, SC (US)

(72) Inventor: Guerry E. GREEN, Georgetown, SC (US)

(21) Appl. No.: 18/604,621

(22) Filed: Mar. 14, 2024

(51) Int. Cl. E05D 15/26; E05C 1/00; E05C 3/04; E06B 3/48; E06B 7/23

(52) U.S. Cl. CPC E05D 15/264; E05C 1/002; E06B 3/481; E06B 7/2316; E05C 3/041; E05Y 2201/684; E05Y 2201/688; E05Y 2900/132

(57) ABSTRACT

A frame and flexible sheet system for an opening includes a top lineal track body with a top weather-stripping lineal, a bottom lineal track body, and an assembly component with articulating frame segment pair, swinging frame segment, and bottom weather-stripping lineals. The system further comprises an engagement and rolling component for the first top corner of the articulating frame segment pair, an engagement and pivoting component for the second top corner, and a bottom lineal track insert anchoring the bottom corner. The articulating frame segment pair is configured to hang from the top lineal track body. This system provides a versatile and efficient solution for enclosing and securing openings to spaces.

### FIELD

This disclosure relates to a component-based frame and flexible sheet system, in particular to a component-based system for adding customizable frames and/or doors to a garage door opening, porch opening, or other large opening, in a home or building, especially for adding features like lites, panels, and/or screens to the opening to protect against weather and insects.

### BACKGROUND

Current approaches for adding customizable frames or doors to large openings, in a home or building, are limited and typically involve permanent, fixed door frames or structural frames added during costly construction, renovation, or remodeling projects. These frames and doors often lack options for screen retention, maintenance, and repair. These frames and doors often lack flexibility and ease of installation, making it difficult for users to customize the frame or door, make fixes, or update to their specific needs and preferences. These frames and doors often are not customizable, or are severely limited in their customization options and capabilities. Furthermore, these may be made out of materials such as wood, that are susceptible to rot, moisture buildup, and constant maintenance.

One approach in the prior art involves the use of sectional doors having multiple horizontal panels configured to retract overhead into a space. These sectional doors may be referred to as roller doors, garage doors, or retractable doors. The panels of these sectional door are commonly made of vinyl, sheet-metals, aluminum, etc. The tracks of these sectional doors are commonly bulky—taking up overhead space and side-space near and around the opening. Moreover, these sectional doors often require the aid of mechanical systems, like coiled springs or motors and pulleys, ropes, or chains, to be safely opened and/or closed. These sectional doors are not intended to have a horizontal panel, or any component, readily removed.

Furthermore, some existing frames or doors may require complex installation processes, involving multiple tools and specialized knowledge. This can be time-consuming and inconvenient for users, especially those without prior experience or expertise in frames or doors. The lack of a prior-art, user-friendly, component-based frame and screen system and, more broadly, a lack of a component-based frame and flexible sheet (e.g., any flexible sheet or panel that is similar to a screen) system, for a garage door opening, or other large opening, has created a need for an improved solution that addresses these limitations, and to provide a maintenance free system for enclosing a space from outdoor elements.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

In some aspects, the techniques described herein relate to a frame and flexible sheet system for an opening to a space, including: (a) a top lineal track body having a top weather-stripping lineal attached to a first side of the top lineal track body, the first side facing the space; (b) a bottom lineal track body; (c) an assembly component, including: (i) an articulating frame segment pair; (ii) a swinging frame segment; and (iii) a bottom weather-stripping lineal attached to each frame segment of the assembly component; (d) an engagement and rolling component for a first top corner of the articulating frame segment pair, configured to roll within the top lineal track body, and whereby the articulating frame segment pair hangs; (e) an engagement and pivoting component for a second top corner of the articulating frame segment pair, configured to be supported by a bottom side of the top lineal track body, and configured to be set in place to fix a pivot axis for the articulating frame segment pair; and (f) a bottom lineal track insert, configured to be received by the bottom lineal track body, and configured to anchor a bottom corner of the articulating frame segment to the bottom lineal track body.

In some aspects, the techniques described herein relate to a frame and flexible sheet system for an opening to a space, including: (a) a top lineal track body having a top weather-stripping lineal attached to a first side of the top lineal track body, the first side facing the space; (b) a bottom lineal track body; (c) a first assembly component and a second assembly component, wherein each assembly component includes: (i) an articulating frame segment pair; (ii) a bottom weather-stripping lineal for each frame segment; (iii) an engagement and rolling component for a first top corner of the articulating frame segment pair, configured to roll within the top lineal track body, and whereby the articulating frame segment pair hangs; (iv) an engagement and pivoting component for a second top corner of the articulating frame segment pair, configured to be supported by a bottom side of the top lineal track body, and configured to be set in place to fix a pivot axis for the articulating frame segment pair; and (v) a bottom lineal track insert, configured to be received by the bottom lineal track body, and configured to anchor a bottom corner of the articulating frame segment pair to the bottom lineal track body and to set the pivot axis; and (d) a swinging frame segment engaged via a butt hinge to the articulating frame segment pair of the first assembly component or the second assembly component.

In some aspects, the techniques described herein relate to a frame and flexible sheet system, including: (a) a top lineal track body defining a wheel track and a top track groove; (b) a bottom lineal track body defining a bottom track groove; (c) a first assembly component, including: (i) a first side, articulating frame segment pair; and (ii) a swinging frame segment; and (d) a second assembly component, including: (i) a second side, articulating frame segment pair; wherein, each articulating frame segment pair includes: a first frame segment including: three side bolt mechanisms each with a retractable bolt; and an engagement mechanism for facilitating a pivot between the first lineal track body and the first frame segment; and a second frame segment including: a side bolt mechanism with retractable bolt; and a wheel track engagement mechanism for engaging the second frame segment to the wheel track of the first lineal track body; and wherein, each bolt mechanism is configured to engage with the top track groove or the bottom track groove, via the retractable bolt.

Additional aspect according to the present disclosure will be set forth in part in the description which follows, and in part will become apparent to those skilled in the art upon examination of the following, or can be learned by practice of the invention.

### BRIEF DESCRIPTION OF THE DRAWINGS

Many aspects of the present disclosure will be better understood with reference to the following drawings and the corresponding written description. The components and features in the drawings are not necessarily to scale, with emphasis instead being placed upon clearly illustrating the aspects according to the present disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1A is a front perspective view of an example component-based system, in a closed configuration, according to the present disclosure.

FIG. 1B is a rear elevation view of an example component-based system, in a closed configuration, according to the present disclosure.

FIG. 1C is front perspective view of an example component-based system, in an intermediate configuration, with a swinging frame segment articulated to a halfway open position, according to the present disclosure.

FIG. 2A is a top plan view of an example component-based system, in a closed configuration, according to the present disclosure.

FIG. 2B is a top plan view of an example component-based system with a swinging frame segment articulated to a halfway open position, according to the present disclosure.

FIG. 2C is a top plan view of an example component-based system with a swinging frame segment articulated to a fully open position, according to the present disclosure.

FIG. 2D is a top plan view of an example component-based system with a first articulating frame segment pair and a second articulating frame segment pair articulated such that the system is in an intermediate configuration, according to the present disclosure.

FIG. 2E is a top plan view of an example component-based system with a first articulating frame segment pair and a second articulating frame segment pair articulated such that the system is in an open configuration, according to the present disclosure.

FIG. 3 is a sectional, side elevation view, taken along the line 3-3 of FIG. 2A, of an example frame segment according to the present disclosure.

FIG. 4 is a sectional, side elevation view, taken along the line 4-4 of FIG. 2A, of an example frame segment according to the present disclosure.

FIG. 5A is bottom perspective view of an example engagement and pivoting component, top lineal track insert, and engagement and rolling component exploded from a top lineal track body, according to the present disclosure.

FIG. 5B is bottom perspective view of an example engagement and pivoting component, top lineal track insert, and engagement and rolling component within a top lineal track body, according to the present disclosure.

FIG. 6A is a magnified top plan view of an example top corner of a frame segment of an articulating frame segment pair with a latch mechanism installed and in a disengaged configuration, according to the present disclosure.

FIG. 6B is a magnified top plan view of an example top corner of a frame segment of an articulating frame segment pair with a latch mechanism installed and in an engaged configuration, according to the present disclosure.

FIG. 7 is magnified rear perspective view of a corner of an example frame segment with exploded flexible screen sheet and installation splines, according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. EXAMPLE USE CASE SCENARIOS

The component-based frame and flexible sheet system for a garage door opening, or other large opening, according to the present disclosure present a novel approach, and one or more technical steps and/or solutions, to addressing the challenges and deficiencies in the prior art. For example, to address the challenges associated with a lack of customization options, and to address the challenges associated with permanent, bulky conventional solutions that often lack easy and efficient installation, maintenance, and repair options.

In one aspect, systems and methods according to the present disclosure provide a versatile, user-friendly, component-based system for adding customizable frames and/or doors to a large opening, and offering unique advantages over conventional systems. In particular, in one aspect, the systems and methods according to the present disclosure allow for features like lites, panels (e.g., decorative, protective, reinforced/hardened), flexible sheets (e.g., screens, opaque privacy shields, flexible impact resistant sheets), and specialty doors/door systems to be added to a garage door opening or other large opening.

In another aspect, the system disclosed herein provides a maintenance free solution for incorporating a barrier between indoor and outdoor elements through a rapid installation kit comprised of vertical panels, frames, doors, and other features that enhance the appearance of large openings, and provide a barrier against insects and weather.

In another aspect, systems and methods according to the present disclosure overcome the challenges and deficiencies in the prior art by providing a component-based system including an assembly(ies) or mechanism(s) having multiple vertical panels, frames, or doors, wherein components of the assembly or mechanism are configured to articulate and to fold or collapse onto each other to convert the system from a closed configuration to an open configuration. For example, in one aspect, the systems and methods according to the present disclosure only demand minimal manual labor to convert the system from the closed configuration to the open configuration, or from the open configuration to the closed configuration. In another example, in one aspect, components of the foldable system may be likened to bi-fold frames or doors, but with support provided by an overhead track, i.e., with the bi-fold frames or doors hanging.

In another aspect, systems and methods according to the present disclosure relate to a component-based system for replacing a garage door with customizable frames and/or doors and, in particular, with frames or doors having flexible sheet-like structures (e.g. screens, screen systems, flexible plastic sheets, flexible glass sheets, flexible impact resistant sheets, etc.).

In another aspect, systems and methods according to the present disclosure relate to a component-based system for augmenting a garage door opening without replacing the garage door. For example, in one aspect, the component-based system may be positioned in front of a closed roller garage door such that, when the roller garage door is retracted or closed, the assembly component-based system may still articulate and open or close. In another example, in one aspect, portions of the component-based system may be selectively removed to allow the roller garage door to retracted or close, or to selectively store the system.

In another aspect, systems and methods according to the present disclosure allow or facilitate permanent installation, or removable attachment, of screens or screen-systems or any other flexible sheet like structures to garage door openings, or other large openings, in areas prone to pests, bugs, and critters, or in areas where concern for opening- and boundary-access is elevated, without compromising aesthetics or décor, when a primary boundary (such as, for example, a garage door) is not being used or is not preferable.

In another aspect, system and methods according to the present disclosure relate to pre-existing frames for openings in a building or structure. For example, in one aspect, systems according to the present disclosures can be added to a garage door opening frame or large opening frame, or generally to the building, structure, or substrate defining the large opening. Moreover, in one aspect, a system according to the present disclosure is a ready-to-install component kit for standard, uniform, or industry/regulated-size garage door openings or other large openings. Furthermore, in another aspect, a system according to the present disclosure is a kit for adding customizable frames and/or doors to a garage door opening or other large opening.

In another aspect, a component-based frame and flexible sheet system according to the present disclosure may be useful for one entire large opening in a building or structure. In particular, in one aspect, an opening may require one or more modular components of the component-based frame and flexible sheet system according to the present disclosure. Furthermore, in one aspect, the component-based frame and flexible sheet system may be expandable by attaching a modular component to another modular component as needed.

In another aspect, the removable and replaceable nature of system components according to the present disclosure (e.g., frames, doors, lineal tracks, lineal accessories, hardware, and mechanisms) is a feature that enhances the system's lifespan and user experience. For example, in one aspect, users of the systems and methods described herein can effortlessly detach and replace individual components for replacement, maintenance, or repair purposes, eliminating the need for extensive dismantling or specialized tools. These aspects address the drawbacks of conventional, permanent solutions by providing a practical and cost-effective improvement for long-term use.

In another aspect, systems and methods according to the present disclosure provide protection for large openings to a modern home or building (e.g., garage door openings, outdoor covered space openings) when the main security barrier(s) (e.g., the roller garage door, security gate, storm shutters) is/are retracted or opened or removed. Moreover, “outdoor architecture,” common to coastal areas, favors more natural light and access to fresh air; thus, the systems and methods according to the present disclosure also provide a technical solution to this field.

In another aspect, the systems and methods according to the present disclosure have an adaptability that extends to multiple functions, serving not only as a component-based door and flexible sheet system for large openings but also as framework for additional features. Thus, in one aspect, systems according to the present disclosure provide for a component-based frame and flexible sheet system wherein the frame components do not come pre-assembled or pre-built as doors, screen doors, or customizable doors, but instead come as an empty frame(s) upon which a user can build, add, or install. For example, in one aspect, each of an articulating frame segment pair or any individual frame segment of the system can accommodate various attachments, such as additional tracks, trims, caps, or dividers, and flexible sheets, decorative panels, or reinforcing structures, offering users a comprehensive solution for diverse architectural needs.

In another aspect, the systems herein provide a maintenance free insulation barrier against outdoor elements. Further, the systems are designed to fit a variety of opening dimensions, thus, able to scale to match any size opening of a garage or other large opening, such as a patio opening, porch opening, or gazebo opening.

In another aspect, the systems according to the present disclosure, or components thereof, as described herein, may be made and/or extruded to match the exterior appearance of a building, opening, or frame, when viewed from the outside, and to have a different interior appearance when viewed from the inside.

### II. SYSTEMS AND METHODS

In one aspect, the present disclosure provides a component-based system for adding frames and/or doors (with or without a flexible sheet) to a large opening to a space (such as a garage door opening to a garage). In another aspect, a component-based system includes a top lineal track body, a bottom lineal track body, and an articulating frame segment pair comprising a hinge between a first frame segment and a second frame segment. In another aspect, the first frame segment of the articulating frame segment pair includes a locking component(s) for locking/preventing articulation, movement, or folding of the articulating frame segment pair, and an engagement and pivoting component for engaging with the top lineal track body. In another aspect, the second frame segment of the articulating frame segment pair includes a locking component(s), and an engagement and rolling component for engaging with the top lineal track body.

In one aspect, frame segments and door segments of a component-based system according to the present disclosure allow for features like lites, panels, flexible sheets, and other add-ons or accessories to be added to an opening, such as a garage door opening. In another aspect, as used herein, the terms “frame segment” and “door segment” may be used interchangeably for convenience; however, the term “frame segment” is intended to be broader. For example, in another aspect, a frame segment serves as an empty frame(s) upon which a user can build, add, or install. Moreover, in another aspect, a frame segment is configured to receive or accommodate additional tracks, trims, caps, mullions, dividers, flexible sheets, decorative panels, glass panels, reinforcing panels or layers, insulation inserts or filling, etc. Moreover, in another aspect, a frame segment is pre-assembled or pre-built to be a door or to operate as a door, at least in part. As such, in another aspect, a frame segment is configured as a pre-assembled or pre-built customizable frame or customizable door that allows the user to add on tracks, trims, caps, mullions, dividers, flexible sheets, decorative panels, glass panels, reinforcing panels or layers, insulation inserts or filling, etc. as needed or as a desired.

In one aspect, a frame segment according to the present disclosure is manufactured using lineal extrusion techniques. For example, in another aspect, a frame segment is made with multiple outdoor-grade PVC lineals that incorporate a reinforcing composite strip(s), such that each frame segment is essentially made of or substantially made of extruded reinforced lineals, except for the hardware (e.g., locking component(s), engagement and pivoting component(s), engagement and rolling component(s), screw(s), fastener(s), door handle(s), door lock(s), etc.).

In one aspect, a top lineal track body and a bottom lineal track body according to the present disclosure is manufactured using lineal extrusion techniques. For example, in another aspect, each of the top lineal track body and the bottom lineal track body incorporates a reinforcing composite strip(s) such that each lineal is reinforced.

In one aspect, an articulating frame segment pair according to the present disclosure is a modular component. In another aspect, an articulating frame segment pair is engaged with another articulating frame segment pair (and with a top lineal track body and a bottom lineal track body according to the present disclosure) to expand a system according to the present disclosure. Moreover, in another aspect, each articulating frame segment pair of a system is part of a separate assembly component for the system, wherein each individual assembly component facilitates the system converting from a closed configuration to an open configuration, or any configuration in between. Furthermore, in another aspect, each assembly component according to the present disclosure has multiple articulating frame segment pairs.

In one aspect, a locking component according to the present disclosure is a bolt mechanism with retractable bolt. In another aspect, a locking component is any other mechanism for locking/preventing articulation, movement, or folding of the articulating frame segment pair. In another aspect, a locking component is any other mechanism for engaging a top lineal track body or a bottom lineal track body according to the present disclosure.

In one aspect, a component-based system according to the present disclosure also includes a top weather-stripping lineal and a bottom weather-stripping lineal. In another aspect, a weather-stripping lineal according to the present disclosure is manufactured using lineal extrusion techniques. For example, in another aspect, a weather-stripping lineal incorporates a reinforcing composite strip(s) such that each lineal is reinforced.

In one aspect, a component-based system according to the present disclosure also includes a swinging frame segment. In another aspect, a swinging frame segment according to the present disclosure is a swinging door segment. In another aspect, a swinging frame segment is engaged with an articulating frame segment pair according to the present disclosure to expand the system. Moreover, in another aspect, each articulating frame segment pair of a system has a swinging frame segment attached thereto. Moreover, in another aspect, each individual assembly component according to the present disclosure includes a swinging frame segment, wherein each individual swinging frame segment facilitates the system converting from a closed configuration to an open configuration, or any configuration in between. Furthermore, in another aspect, a swinging frame segment engages with an adjacent assembly component or an adjacent articulating frame segment pair to form a door system that is configured to close, lock, and/or securely bolt. Furthermore, in another aspect, two swinging frame segments of adjacent assembly components, or adjacent articulating frame segment pairs, may engage to form a door system configured to close, lock, or securely bolt.

In one aspect, the present disclosure provides a component-based system for an opening to a space including a top lineal track body, a bottom lineal track body, a first assembly component, and a second assembly component. In another aspect, a first assembly component according to the present disclosure includes an articulating frame segment pair and a swinging frame segment. Similarly, in one aspect, a second assembly component according to the present disclosure includes an articulating frame segment pair but no swinging frame segment. Moreover, in another aspect, an articulating frame segment pair according to the present disclosure includes a first frame segment having a locking component and an engagement and pivoting mechanism for engaging with the top lineal track body. Moreover, in another aspect, an articulating frame segment pair also includes a second frame segment having a locking component and an engagement and rolling mechanism for engaging with the top lineal track body.

In another aspect, the present disclosure provides a component-based system for an opening to a space including (a) a top lineal track body having a top weather-stripping lineal attached thereto; (b) a bottom lineal track body; (c) an assembly component, including: (i) an articulating frame segment pair; (ii) a swinging frame segment; and (iii) a bottom weather-stripping lineal attached to each frame segment of the assembly component; (d) an engagement and rolling component for a first top corner of the articulating frame segment pair, configured to roll within the top lineal track body, and whereby the articulating frame segment pair hangs; (e) an engagement and pivoting component for a second top corner of the articulating frame segment pair, configured to be supported by a bottom side of the top lineal track body, and configured to be set in place to fix a pivot axis for the articulating frame segment pair; and (f) a bottom lineal track insert, configured to be received by the bottom lineal track body, and configured to anchor a bottom corner of the articulating frame segment to the bottom lineal track body.

In one aspect, an articulating frame segment pair according to the present disclosure includes a first frame segment and a second frame segment, engaged via a hinge, and the articulating frame segment pair hangs from the top lineal track body at a first corner and at a second corner. In another aspect, each of the frame segments of an articulating pair includes a top corner, and an engagement and rolling component according to the present disclosure is situated at the top corner of the first frame segment and an engagement and pivoting component according to the present disclosure is situated at the top corner of the second frame segment. In another aspect, a hinge for the articulating frame segment pair, according to the present disclosure, is configured as a butt hinge between the first frame segment and the second frame segment. In another aspect, a hinge is any hinge mechanism or means for articulating frame segments or door segments; however, a hinge that restricts full articulation or pivoting about a pivot axis is preferred as it affords additional security.

In one aspect, the present disclosure provides a component-based system for an opening to a space including: (a) a top lineal track body having a top weather-stripping lineal attached thereto; (b) a bottom lineal track body; (c) a first assembly component and a second assembly component, wherein each assembly component includes: (i) an articulating frame segment pair; (ii) a bottom weather-stripping lineal for each frame segment; (iii) an engagement and rolling component for a first top corner of the articulating frame segment pair, configured to roll within the top lineal track body, and whereby the articulating frame segment pair hangs; (iv) an engagement and pivoting component for a second top corner of the articulating frame segment pair; and (v) a bottom lineal track insert, configured to be received by the bottom lineal track body, and configured to anchor a bottom corner of the articulating frame segment pair to the bottom lineal track body; and (d) a swinging frame segment engaged to the articulating frame segment pair of the first assembly component or the second assembly component.

In one aspect, a top lineal track body according to the present disclosure defines an internal wheel track and a track groove. In another aspect, an engagement and rolling component according to the present disclosure is configured to roll within the top lineal track body along the internal wheel track.

In one aspect, an engagement and rolling component according to the present disclosure includes an engagement prong. In another aspect, a first top corner of an articulating frame segment pair according to the present disclosure is configured to receive and securely latch the engagement prong such that the first top corner hangs from the engagement and rolling component.

In one aspect, a bottom lineal track body according to the present disclosure defines a track groove. In another aspect, a bottom lineal track insert according to the present disclosure is configured to be received by the track groove and anchored in place via a screw to set a pivot axis of an articulating frame segment pair.

In one aspect, a bottom corner of an articulating frame segment pair according to the present disclosure includes a bolt mechanism with retractable bolt configured to be received by the bottom lineal track insert to set a pivot axis of an articulating frame segment pair.

In one aspect, a component-based system according to the present disclosure also includes a first swinging frame segment, according to the present disclosure, engaged to an articulating frame segment pair of a first assembly component, and includes a second swinging frame segment engaged to the articulating frame segment pair of a second assembly component. In another aspect, a first swinging frame segment and a second swinging frame segment are configured as double doors.

In one aspect, the present disclosure provides a component-based system for an opening to a space including: (a) a top lineal track body defining a wheel track and a top track groove; (b) a bottom lineal track body defining a bottom track groove; (c) a first assembly component, including: (i) a first articulating frame segment pair; and (ii) a swinging frame segment; and (d) a second assembly component, including: (i) a second articulating frame segment pair; wherein, each articulating frame segment pair includes: a first frame segment including: a bolt mechanisms with retractable bolt and an engagement mechanism for facilitating a pivot between the first lineal track body and the first frame segment; and a second frame segment including: a bolt mechanism with retractable bolt and an engagement mechanism for engaging the second frame segment to the first lineal track body; and wherein, each bolt mechanism is configured to engage with the top track groove or the bottom track groove, via the retractable bolt.

### III. WITH REFERENCE TO THE FIGURES

U.S. Pat. Nos. 9,981,411 and 10,773,431 and United States Patent International Application Number US20202/042159, are assigned to the Applicant of the present application, and are incorporated herein in their entirety by reference.

The term “lineal” refers to an extruded component (e.g., member, piece, etc.) having a uniform cross section perpendicular to its major dimension which major dimension is much longer than its other two dimensions; that is, the plane of any cross section perpendicular to the major dimension is defined by a line parallel to the major dimension.

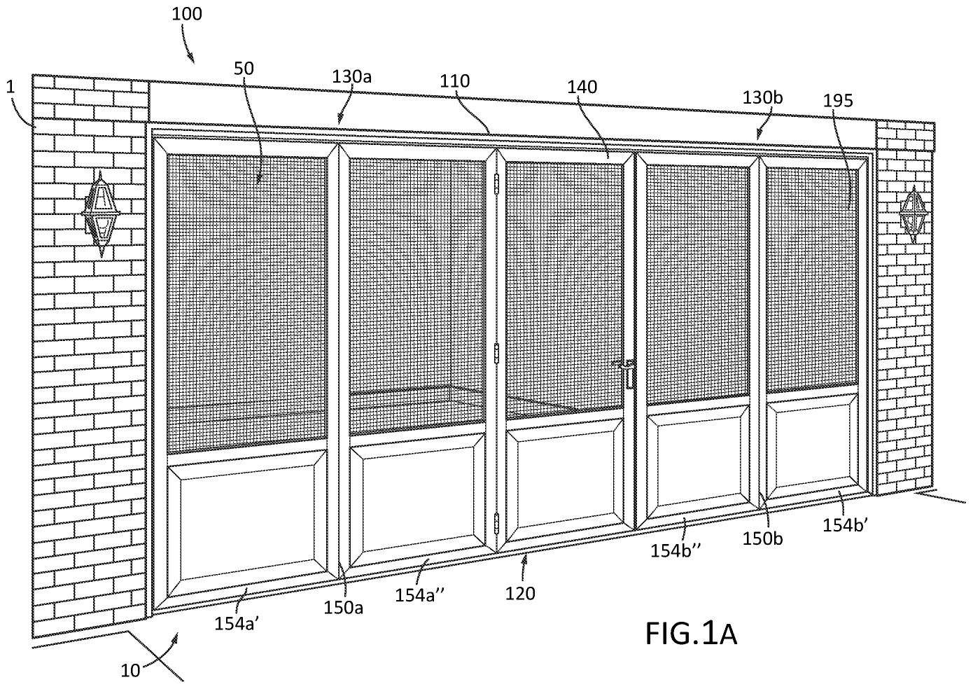

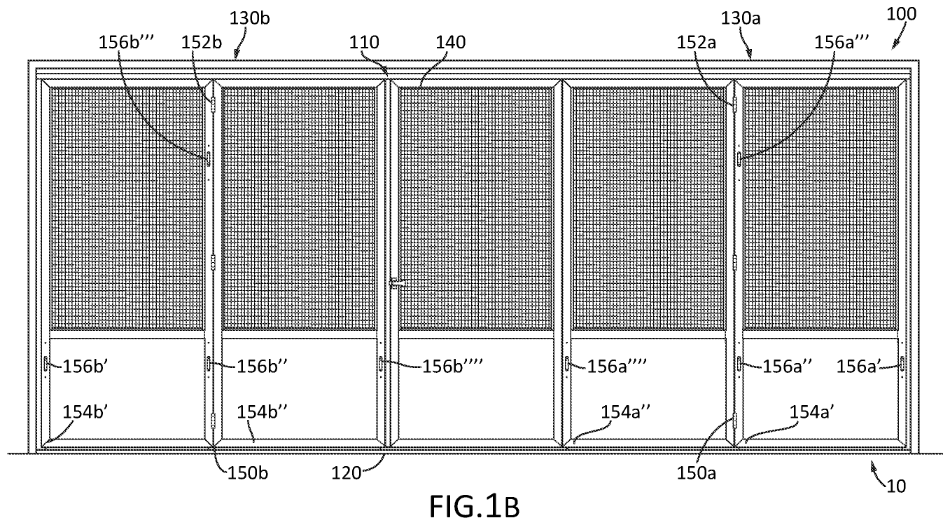

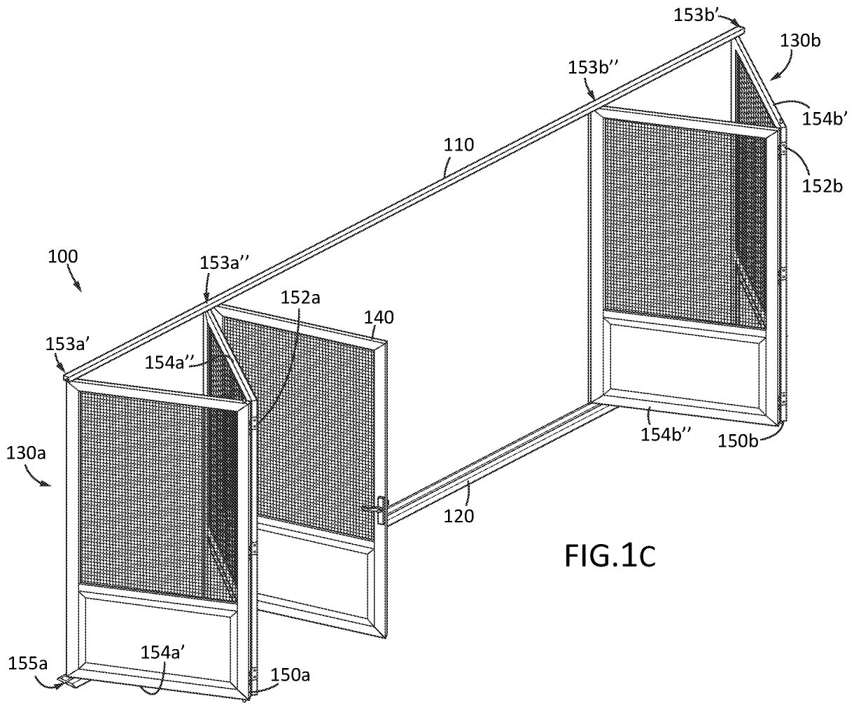

Turning now to the FIGS., FIG. 1A is a front perspective view of an example component-based system, in a closed configuration, according to the present disclosure; FIG. 1B is a rear elevation view of an example component-based system, in a closed configuration, according to the present disclosure; and FIG. 1C is front perspective view of an example component-based system, in an intermediate configuration, with a swinging frame segment articulated to a halfway open position, according to the present disclosure.

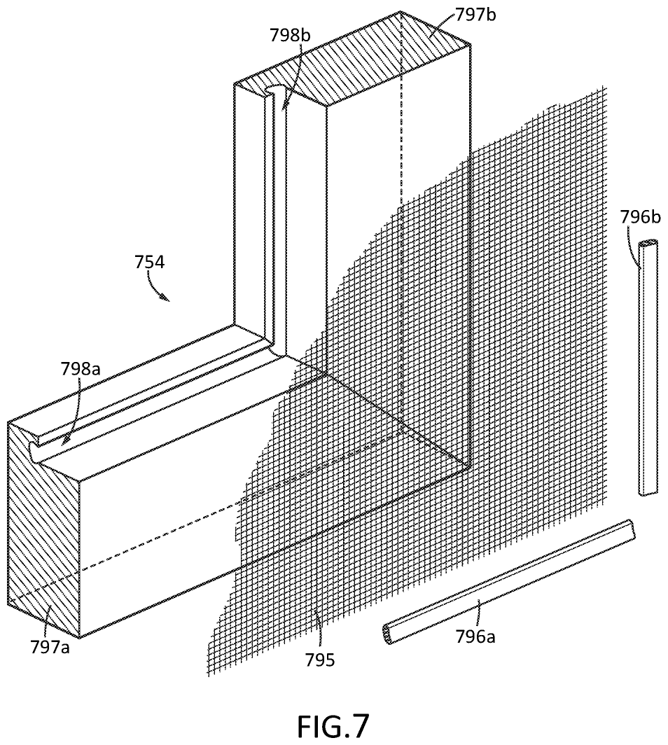

In particular, in FIGS. 1A-1C, there is shown a building 1 defining an opening 10 that accesses a space 50 and, more specifically, there is shown a home defining a garage door opening accessing a garage. Moreover, there is shown a component-based system 100 added to the opening 10 and, more specifically, there is shown a component-based frame and screen system for adding frames and/or doors (with or without a flexible sheet; best seen in FIG. 7) to a garage door opening, or to another large opening.

In one aspect, as illustrated, the component-based system 100 includes a top lineal track body 110, a bottom lineal track body 120, a first assembly component 130a, and a second assembly component 130b. The component-based system 100 also includes a swinging frame segment 140, a first articulating frame segment pair 150a, and a second articulating frame segment pair 150b. In particular, the first assembly component 130a includes the swinging frame segment 140 and the first articulating frame segment pair 150a, the second assembly component 130b includes the second articulating frame segment pair 150b. Moreover, the first articulating frame segment pair 150a includes a hinge 152a (best seen in FIG. 1B; in one aspect, is a butt hinge) between a first frame segment 154a′ and a second frame segment 154a″. Similarly, the second articulating frame segment pair 150b includes a hinge 152b (best seen in FIG. 1B) between a first frame segment 154b′ and a second frame segment 154b″. Furthermore, each frame segment 154 of the system 100 includes a removable/replaceable flexible screen sheet 195.

In another aspect, as illustrated in FIG. 1B, the first frame segment 154a′ and the first frame segment 154b′ each, respectively, include three side bolt mechanisms 156a (e.g., a side bolt mechanism 156a′, a side bolt mechanism 156a″, and a side bolt mechanism 156a′″) or three side bolt mechanisms 156b (e.g., a side bolt mechanism 156b′, a side bolt mechanism 156b″, and a side bolt mechanism 156b′″). Similarly, the second frame segment 154a″ includes a side bolt mechanism 156a″″ and the second frame segment 154b″ includes a side bolt mechanism 156b″″. The side bolt mechanisms 156a are configured to prevent articulation of the articulating frame segment pair 150a. The side bolt mechanisms 156b are configured to prevent articulation of the articulating frame segment pair 150b.

In another aspect, as best illustrated in FIG. 1C, the first frame segment 154a′ includes a top corner 153a′ and a bottom corner 155a and the first frame segment 154b′ has a top corner 153b′ and a bottom corner 155b (not shown; obscured). Similarly, the second frame segment 154a″ includes a top corner 153a″ and the second frame segment 154b″ has a top corner 153b″. As such, the articulating frame segment pair 150a hangs from the top lineal track body 110 at the top corner 153a′ and at the top corner 153a″. Moreover, the articulating frame segment pair 150b hangs from the top lineal track body 110 at the top corner 153b′ and at the top corner 153b″.

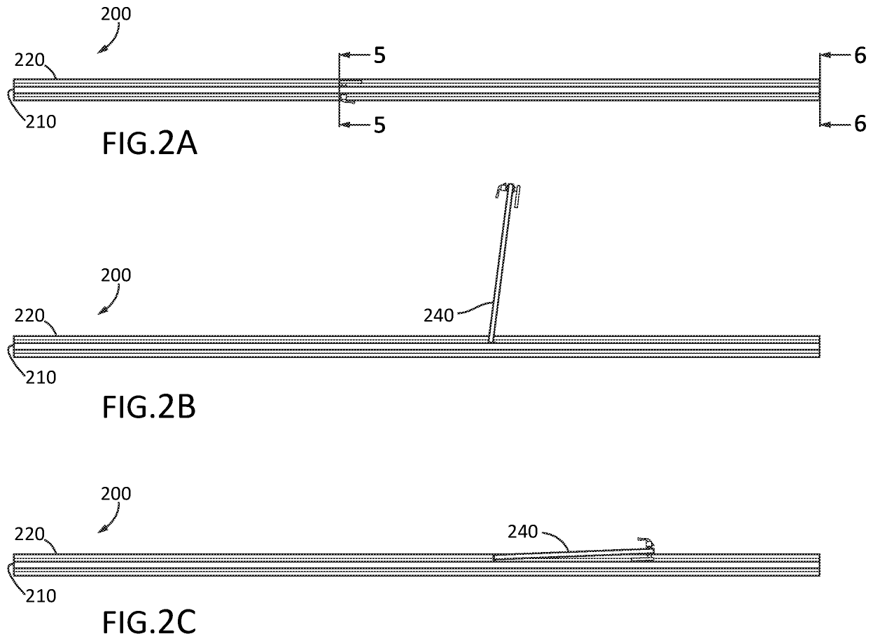

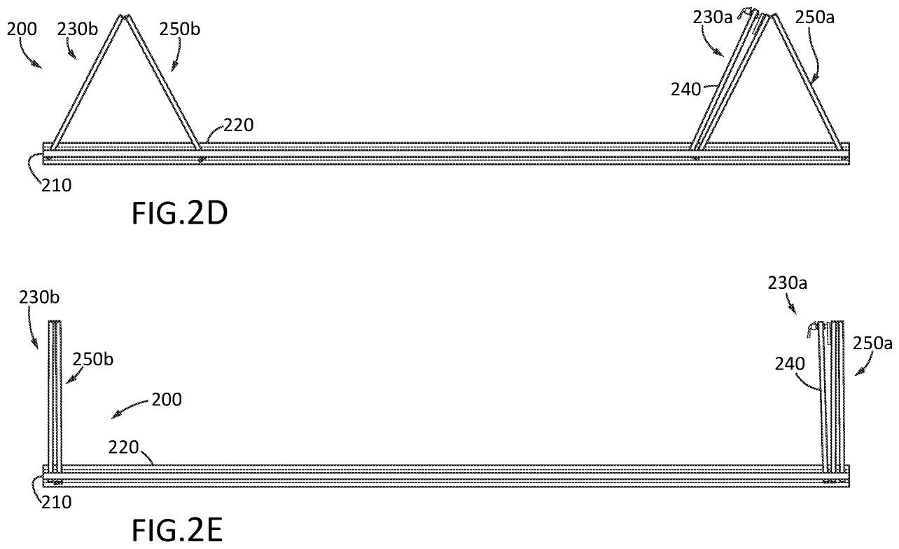

Turning now to FIGS. 2A-2E, FIG. 2A is a top plan view of an example component-based system, in a closed configuration, according to the present disclosure; FIG. 2B is a top plan view of an example component-based system with a swinging frame segment articulated to a halfway open position, according to the present disclosure; FIG. 2C is a top plan view of an example component-based system with a swinging frame segment articulated to a fully open position, according to the present disclosure; FIG. 2D is a top plan view of an example component-based system with a first articulating frame segment pair and a second articulating frame segment pair articulated such that the system is in an intermediate configuration, according to the present disclosure; and FIG. 2E is a top plan view of an example component-based system with a first articulating frame segment pair and a second articulating frame segment pair articulated such that the system is in an open configuration, according to the present disclosure.

In one aspect, as illustrated, the component-based system 200 includes a top lineal track body 210, a bottom lineal track body 220, a first assembly component 230a, and a second assembly component 230b. The component-based system 200 also includes a first assembly component 230a having a swinging frame segment 240 and a first articulating frame segment pair 250a, and a second assembly component 230b includes a second articulating frame segment pair 250b.

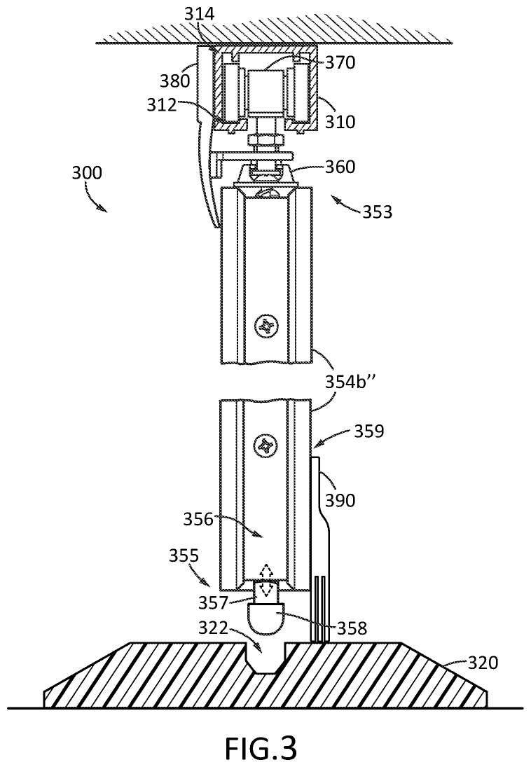

FIG. 3 is a sectional, side elevation view, taken along the line 3-3 of FIG. 2A, of an example frame segment according to the present disclosure. In particular, in FIG. 3, there is shown a side elevation view, in the direction of the arrows 3-3 of FIG. 2A, of a second frame segment 254b″ of an articulating frame segment pair 250b, but for, as part of a system 300 (with updated 300 series numbers).

More specifically, as illustrated, the system 300 includes a top lineal track body 310 defining an internal wheel track 312; a bottom lineal track body 320 having a top side defining a bottom track groove 322; and a frame segment 354b″ having, at a bottom corner 355, a side bolt mechanism 356 with a retractable bolt 357 capped by a plunger cap 358 and configured to engage with the bottom track groove 322.

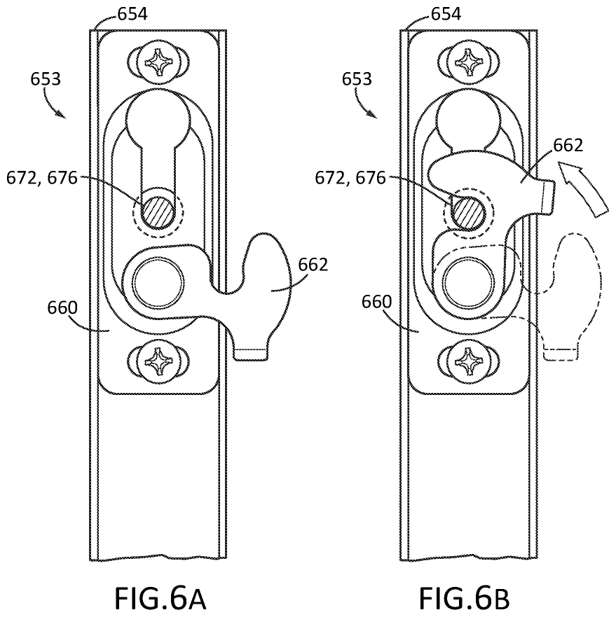

In one aspect, as illustrated, the frame segment 354b″ includes a latch mechanism 360 (best seen in FIGS. 6A and 6B) installed on a top corner 353. The latch mechanism 360 can be seen as part of the engagement and rolling component 370, or the latch mechanism 360 can be its own component operating as a sub-assembly with the engagement and rolling component 370, for engaging with the top lineal track body.

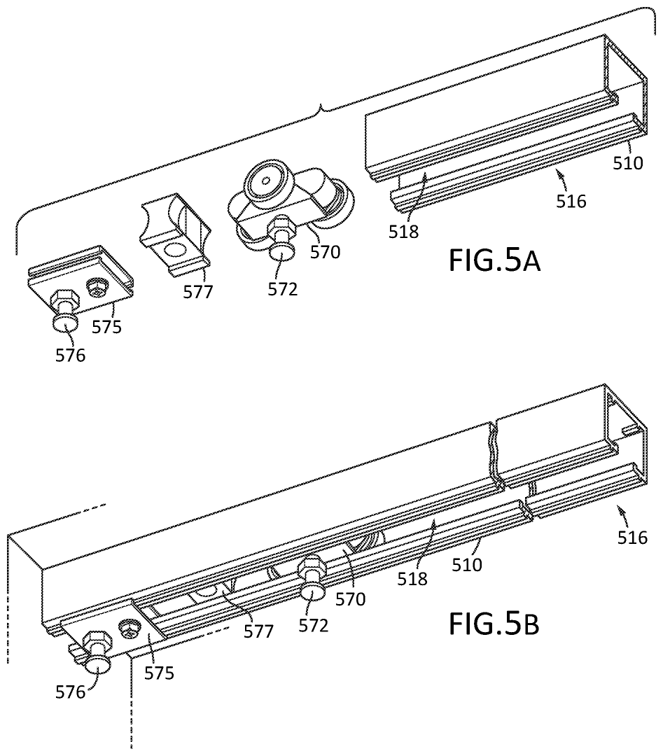

In another aspect, as illustrated, an engagement and rolling component 370 (best seen in FIGS. 5A and 5B) is situated at the top corner 353 for engaging with the top lineal track body 310 and for engaging with the latch mechanism 360 of the frame segment 354b″. In particular, the engagement and rolling component 370 is situated within the top lineal track body 310 such that the engagement and rolling component 370 can roll along the internal wheel track 312. In this way, the frame segment 354b″ is configured to hang from the top lineal track body 310.

In another aspect, as illustrated, a top weather-stripping lineal 380 is attached to a first side 314 of the top lineal track body 310, and the first side 314 is facing the space 50 (in FIGS. 1A-1C, the space 50 is a garage). Moreover, a bottom weather-stripping lineal 390 is attached to the bottom side 359 of the frame segment 354b″.

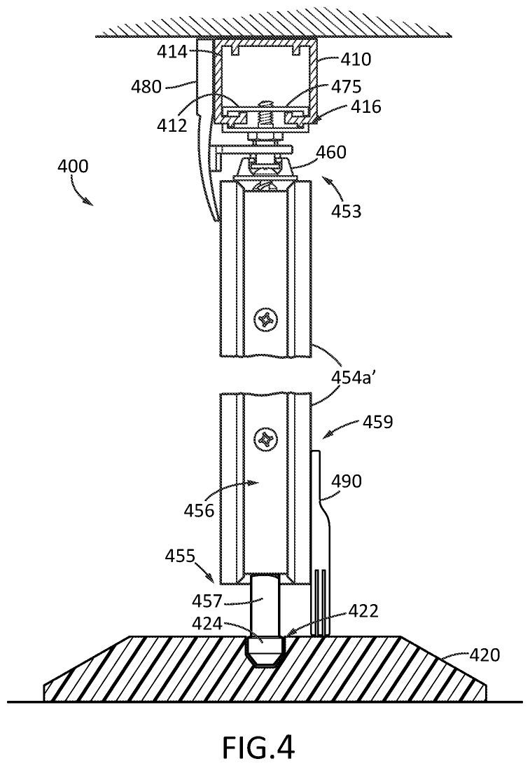

FIG. 4 is a sectional, side elevation view, taken along the line 4-4 of FIG. 2A, of an example frame segment according to the present disclosure. In particular, in FIG. 4, there is shown a side elevation view, in the direction of the arrows 4-4 of FIG. 2A, of a first frame segment 254a′ of an articulating frame segment pair 250a, but for, as part of a system 400 (with updated 400 series numbers).

More specifically, as illustrated, the system 400 includes: a top lineal track body 410 defining an internal wheel track 412 and having a first side 414 with a top weather-stripping lineal 480 engage thereto; a bottom lineal track body 420 defining a bottom track groove 422; and a frame segment 454a′ having, at a top corner 453, a latch mechanism 460, and having, at a bottom corner 355, a side bolt mechanism 456 with a retractable bolt 457 configured to engage with the bottom track groove 422, and having a bottom side 459 with a bottom weather-stripping lineal 490 engaged thereto.

In one aspect, as illustrated, the system 400 also includes a bottom lineal track insert 424. The shape of the bottom lineal track insert 424 complements that shape of the bottom track groove 422, and the bottom lineal track insert is configured to be received by the bottom track groove 422 and anchored in place via a screw (not shown; configured to screw into the bottom lineal track insert and no further or configured to receive concrete or other substrate anchoring screws). Moreover, the side bolt mechanism 456 with the retractable bolt 457 at the bottom corner 455 of the frame segment 454a′ is configured to be received by the bottom lineal track insert 424 to set or fix a pivot axis for the frame segment 454a′. As such, the bottom lineal track insert 424 is configured to anchor a bottom corner 455 of the frame segment 454a′ to the bottom lineal track body 420.

In another aspect, as illustrated, an engagement and pivoting component 475 (best seen in FIGS. 5A and 5B) is situated at the top corner 453 for engaging with the top lineal track body 410 and for engaging with the latch mechanism 460 of the frame segment 454a′. In particular, the engagement and pivoting component 475 is supported by a bottom side 416 of the top lineal track body 410. As such, the engagement and pivoting component 475 is configured to be set in place (best seen in FIGS. 5A and 5B) along the bottom side 416 of the top lineal track body 410 to fix a pivot axis for the frame segment 454a′. Moreover, the frame segment 454a′ is configured to hang from the top lineal track body 410.

Turning to FIGS. 5A and 5B, FIG. 5A is bottom perspective view of an example engagement and pivoting component, top lineal track insert, and engagement and rolling component exploded from a top lineal track body, according to the present disclosure; and FIG. 5B is bottom perspective view of an example engagement and pivoting component, top lineal track insert, and engagement and rolling component within a top lineal track body, according to the present disclosure.

In particular, in FIGS. 5A and 5B, there is shown a top lineal track body 510 having an internal wheel track 512 (not shown; best seen in FIG. 3) and a bottom side 516 defining a top track groove 518; an engagement and rolling component 570 having an engagement prong 572; an engagement and pivoting component 575 having an engagement prong 576; and a top lineal track insert or spacer 577.

In one aspect, as illustrated, the engagement and rolling component 570 is configured to slide or roll into the inside of the top lineal track body 510 such that the engagement and rolling component 570 can roll along the internal wheel track 512, and such that the engagement prong 572 can extend through the top track groove 518. In this way, the engagement and rolling component 570 is configured to engage with a latch mechanism of a frame segment, for example, and the corresponding frame segment is configured to hang from the top lineal track body 510. Moreover, in another aspect, the engagement and rolling component 570 is considered to be a wheel track engagement mechanism.

In another aspect, as illustrated, the engagement and pivoting component 575 is configured to slide onto the bottom side 516 of the top lineal track body 510, to be positioned, and to be tightened, such that the engagement and pivoting component 575 is supported by the bottom side 516, and such that the engagement and pivoting component 575 fixes a pivot axis in place, and such that the engagement prong 576 extends away from the engagement and pivoting component 575. In this way, the engagement and pivoting component 575 is configured to engage with a latch mechanism of a frame segment, for example, and the corresponding frame segment is configured to hang from the top lineal track body 510.

Turning now to FIGS. 6A and 6B, FIG. 6A is a magnified top plan view of an example top corner of a frame segment of an articulating frame segment pair with a latch mechanism installed and in a disengaged configuration, according to the present disclosure; and FIG. 6B is a magnified top plan view of an example top corner of a frame segment of an articulating frame segment pair with a latch mechanism installed and in an engaged configuration, according to the present disclosure.

In particular, in FIGS. 6A and 6B, there is shown a frame segment 654 having, at a top corner 653 with a latch mechanism 660 installed. The latch mechanism 660 includes a latch 662 that can articulate from an open position (best seen in FIG. 6A) to a closed position (best seen in FIG. 6B). In this way, the top corner 653 of a frame segment according to the present disclosure is configured to receive and securely latch, for example, an engagement prong 672 or an engagement prong 676 such that the first top corner (and, therefore, the corresponding frame segment) hangs from the engagement prong.

FIG. 7 is magnified rear perspective view of a corner of an example frame segment with exploded flexible screen sheet and installation splines, according to the present disclosure. In particular, in FIG. 7, there is shown a frame segment 754 with a screen 795 removed. The screen 795 is an example of a replaceable flexible sheet according to the present disclosure. The screen 795 is removable by removing lineal spline 796a and lineal spline 796b and any other spline.

In one aspect, as illustrated, lineal member 797a and lineal member 797b and other lineal members (not shown) are assembled to make the frame segment 754. The lineal member 797a defines a spline groove 798a for receiving the spline 796a and for holding at least part of the screen 795. Similarly, the lineal member 797b defines a spline groove 798b for receiving the spline 796b and for holding at least part of the screen 795.

Many different arrangements or combinations of the various aspects and/or steps depicted and described, as well as those not shown, are possible without departing from the scope of the claims below. Aspect according to the present disclosure have been described with the intent to be illustrative rather than restrictive. Alternative aspects and aspect combinations will become apparent from reference to this disclosure. Alternative means or embodiments of implementing the aforementioned can be completed without departing from the scope of the claims below. Certain features and subcombinations are of utility and can be employed without reference to other features and subcombinations and are contemplated within the scope of the claims. Aspects according to the present disclosure should not suffer intermediate generalization or be necessarily grouped with other aspects simply because they are described in the same paragraph of the written description.

### IV. EMBODIMENTS

Certain implementations of systems and methods consistent with the present disclosure are provided as follows:

Clause 1. A frame and screen system for an opening to a space, comprising: (a) a top lineal track body having a top weather-stripping lineal attached to a first side of the top lineal track body, the first side facing the space; (b) a bottom lineal track body; (c) an assembly component, comprising: (i) an articulating frame segment pair; (ii) a swinging frame segment; and (iii) a bottom weather-stripping lineal attached to each frame segment of the assembly component; (d) an engagement and rolling component for a first top corner of the articulating frame segment pair, configured to roll within the top lineal track body, and whereby the articulating frame segment pair hangs; (e) an engagement and pivoting component for a second top corner of the articulating frame segment pair, configured to be supported by a bottom side of the top lineal track body, and configured to be set in place to fix a pivot axis for the articulating frame segment pair; and (f) a bottom lineal track insert, configured to be received by the bottom lineal track body, and configured to anchor a bottom corner of the articulating frame segment pair to the bottom lineal track body.

Clause 2. The frame and screen system of clause 1, wherein the articulating frame segment pair comprises a first frame segment comprising the first top corner, and wherein the first top corner hangs from the engagement and rolling component.

Clause 3. The frame and screen system of clause 2, wherein the articulating frame segment pair comprises a second frame segment comprising the second top corner, and wherein the second frame segment hangs from the engagement and pivoting component.

Clause 4. The frame and screen system of clause 3, wherein the articulating frame segment pair comprises a butt hinge between the first frame segment and the second frame segment.

Clause 5. A frame and screen system for an opening to a space, comprising: (a) a top lineal track body having a top weather-stripping lineal attached to a first side of the top lineal track body, the first side facing the space; (b) a bottom lineal track body; (c) a first assembly component and a second assembly component, wherein each assembly component comprises: (i) an articulating frame segment pair; (ii) a bottom weather-stripping lineal for each frame segment; (iii) an engagement and rolling component for a first top corner of the articulating frame segment pair, configured to roll within the top lineal track body, and whereby the articulating frame segment pair hangs; (iv) an engagement and pivoting component for a second top corner of the articulating frame segment pair, configured to be supported by a bottom side of the top lineal track body, and configured to be set in place to fix a pivot axis for the articulating frame segment pair; and (v) a bottom lineal track insert, configured to be received by the bottom lineal track body, and configured to anchor a bottom corner of the articulating frame segment pair to the bottom lineal track body and to set the pivot axis; and (d) a swinging frame segment engaged via a butt hinge to the articulating frame segment pair of the first assembly component or the second assembly component.

Clause 6. The frame and screen system of clause 5, wherein the articulating frame segment pair comprises a first frame segment comprising the first top corner, and wherein the first top corner hangs from the engagement and rolling component.

Clause 7. The frame and screen system of clause 6, wherein the articulating frame segment pair comprises a second frame segment comprising the second top corner, and wherein the second frame segment hangs from the engagement and pivoting component.

Clause 8. The frame and screen system of clause 7, wherein the top lineal track body defines an internal wheel track and a track groove, wherein the track groove is on the bottom side of the top lineal track body, and wherein the engagement and rolling component is configured to roll within the top lineal track body along the internal wheel track.

Clause 9. The frame and screen system of clause 8, wherein the engagement and rolling component comprises an engagement prong configured to extend through the bottom side of the top lineal track body via the track groove, and wherein the first top corner is configured to receive and securely latch the engagement prong such that the first top corner hangs from the engagement and rolling component.

Clause 10. The frame and screen system of clause 7, wherein the bottom lineal track body defines a track groove, wherein the track groove is on a top side of the bottom lineal track body, and wherein the bottom lineal track insert is configured to be received by the track groove and anchored in place via a screw to set the pivot axis of the articulating frame segment pair.

Clause 11. The frame and screen system of clause 10, wherein the bottom corner comprises a retractable bolt, and wherein the retractable bolt is configured to be received by the bottom lineal track insert to set the pivot axis.

Clause 12. The frame and screen system of clause 5, wherein the swinging frame segment is configured as a door.

Clause 13. The frame and screen system of clause 5, wherein the swinging frame segment is a first swinging frame segment engaged to the first assembly component, and wherein a second swinging frame segment is engaged to the articulating frame segment pair of the second assembly component.

Clause 14. The frame and screen system of clause 13, wherein the first swinging frame segment and the second swinging frame segment are configured as double doors.

Clause 15. A frame and screen system, comprising: (a) a top lineal track body defining a wheel track and a top track groove; (b) a bottom lineal track body defining a bottom track groove; (c) a first assembly component, comprising: (i) a first side, articulating frame segment pair; and (ii) a swinging frame segment; and (d) a second assembly component, comprising: (i) a second side, articulating frame segment pair; wherein, each articulating frame segment pair comprises: a first frame segment comprising: three side bolt mechanisms each with a retractable bolt; and an engagement mechanism for facilitating a pivot between the top lineal track body and the first frame segment; and a second frame segment comprising: a side bolt mechanism with retractable bolt; and a wheel track engagement mechanism for engaging the second frame segment to the wheel track of the top lineal track body; and wherein, each bolt mechanism is configured to engage with the top track groove or the bottom track groove, via the retractable bolt.

Clause 16. The frame and screen system of clause 15, further comprising a top weather-stripping lineal attached to the top lineal track body.

Clause 17. The frame and screen system of clause 15, further comprising a bottom weather-stripping lineal attached to each frame segment of the first assembly component and the second assembly component.

Clause 18. The frame and screen system of clause 15, wherein two side bolt mechanisms of the three side bolt mechanisms of the first frame segment are configured to engage with the bottom track groove, via the retractable bolt.

Clause 19. The frame and screen system of clause 18, wherein one side bolt mechanism of the three side bolt mechanisms of the first frame segment are configured to engage with the top track groove, via the retractable bolt.

Clause 20. The frame and screen system of clause 15, wherein the side bolt mechanism of the second frame segment is configured to engage with the bottom track groove, via the retractable bolt.

Clause 21. A frame and screen system, comprising: a first lineal track body; a second lineal track body; and an articulating frame segment pair, comprising: a hinge between; a first frame segment, comprising: at least two side bolt mechanisms; and an engagement and pivoting mechanism for engaging with the first lineal track body; and a second frame segment, comprising: no more than two side bolt mechanisms; and an engagement and rolling mechanism for engaging with the first lineal track body.

Clause 22. A frame and screen system, comprising: a first lineal track body; a second lineal track body; a first articulating frame segment pair; and a second articulating frame segment pair; wherein, each articulating frame segment pair comprises: a hinge between; a first frame segment, comprising: at least two side bolt mechanisms; and an engagement and pivoting mechanism for engaging with the first lineal track body; and a second frame segment, comprising: no more than two side bolt mechanisms; and an engagement and rolling mechanism for engaging with the first lineal track body.

Clause 23: A frame and screen system, comprising: a first lineal track body; a second lineal track body; a first assembly, comprising: a first side, articulating frame segment pair; and a swinging frame segment; and a second assembly, comprising: a second side, articulating frame segment pair; wherein, each articulating frame segment pair comprises: a first frame segment comprising: three side bolt mechanisms; and an engagement and pivoting mechanism for engaging with the first lineal track body; and a second frame segment comprising: a side bolt mechanism; and an engagement and rolling mechanism for engaging with the first lineal track body; and a hinge, whereby the first frame segment and the second frame segment articulate.

Clause 24: A frame and screen system, comprising: a first lineal track body; a second lineal track body; a first assembly, comprising: a first side, articulating frame segment pair; and a swinging frame segment; and a second assembly, comprising: a second side, articulating frame segment pair; wherein, each articulating frame segment pair comprises: a first frame segment comprising: three side bolt mechanisms; and an engagement and pivoting mechanism for engaging with the first lineal track body; and a second frame segment comprising: a side bolt mechanism; and an engagement and rolling mechanism for engaging with the first lineal track body; and a hinge, whereby the first frame segment and the second frame segment articulate.

Clause 25: A component based frame and screen system, comprising: a top track lineal defining an internal wheel track and a top track groove; a bottom track lineal defining a bottom track groove; a first side assembly, comprising: a left side articulating frame segment pair; and a left side swinging frame segment; and a second side assembly, comprising: a right side articulating frame segment pair; wherein, each articulating frame segment pair comprises: a first frame segment comprising: a bottom left side bolt mechanism with retractable bolt; a bottom right side bolt mechanism with retractable bolt; and a top right side bolt mechanism with retractable bolt; a top track engagement mechanism for engaging the first frame segment to the top track lineal; and a second frame segment comprising: a bottom right side bolt mechanism with retractable bolt; and a top track engagement and rolling mechanism for engaging the second frame segment to the top track lineal, via the internal wheel track and the top track groove; and a butt hinge, whereby the first frame segment and the second frame segment articulate; and wherein, each bolt mechanism is configured to engage with the bottom track groove of the bottom track lineal, via the retractable bolt.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A frame and flexible sheet system for an opening to a space, comprising:
a. a top lineal track body with reinforcing composite strip having a top weather-stripping lineal attached to a first side of the top lineal track body, the first side facing the space;
b. a bottom lineal track body with a reinforcing composite strip;
c. an assembly component, comprising:
i. an articulating frame segment pair;
ii. a swinging frame segment; and
iii. a bottom weather-stripping lineal attached to each frame segment of the assembly component;
d. an engagement and rolling component for a first top corner of the articulating frame segment pair, configured to roll within the top lineal track body, and whereby the articulating frame segment pair hangs;
e. an engagement and pivoting component for a second top corner of the articulating frame segment pair, configured to be supported by a bottom side of the top lineal track body, and configured to be set in place to fix a pivot axis for the articulating frame segment pair; and
f. a bottom lineal track insert, configured to be received by the bottom lineal track body, configured to engage with the bottom weather-stripping lineal, and configured to anchor a bottom corner of the articulating frame segment pair to the bottom lineal track body.

2. The frame and flexible sheet system of claim 1, wherein the articulating frame segment pair comprises a first frame segment comprising the first top corner, and wherein the first top corner hangs from the engagement and rolling component.

3. The frame and flexible sheet system of claim 2, wherein the articulating frame segment pair comprises a second frame segment comprising the second top corner, and wherein the second frame segment hangs from the engagement and pivoting component.

4. The frame and flexible sheet system of claim 3, wherein the articulating frame segment pair comprises a butt hinge between the first frame segment and the second frame segment.

5. A frame and flexible sheet system for an opening to a space, comprising:
a. a top lineal track body with a reinforcing composite strip having a top weather-stripping lineal attached to a first side of the top lineal track body, the first side facing the space;
b. a bottom lineal track body with a reinforcing composite strip;
c. a first assembly component and a second assembly component, wherein each assembly component comprises:
i. an articulating frame segment pair;
ii. a bottom weather-stripping lineal for each frame segment configured to engage with the bottom lineal track body;
iii. an engagement and rolling component for a first top corner of the articulating frame segment pair, configured to roll within the top lineal track body, and whereby the articulating frame segment pair hangs;
iv. an engagement and pivoting component for a second top corner of the articulating frame segment pair, configured to be supported by a bottom side of the top lineal track body, and configured to be set in place to fix a pivot axis for the articulating frame segment pair; and
v. a bottom lineal track insert, configured to be received by the bottom lineal track body, and configured to anchor a bottom corner of the articulating frame segment pair to the bottom lineal track body and to set the pivot axis; and
d. a swinging frame segment engaged via a butt hinge to the articulating frame segment pair of the first assembly component or the second assembly component.

6. The frame and flexible sheet system of claim 5, wherein the articulating frame segment pair comprises a first frame segment comprising the first top corner, and wherein the first top corner hangs from the engagement and rolling component.

7. The frame and flexible sheet system of claim 6, wherein the articulating frame segment pair comprises a second frame segment comprising the second top corner, and wherein the second frame segment hangs from the engagement and pivoting component.

8. The frame and flexible sheet system of claim 7, wherein the top lineal track body defines an internal wheel track and a track groove, wherein the track groove is on the bottom side of the top lineal track body, and wherein the engagement and rolling component is configured to roll within the top lineal track body along the internal wheel track.

9. The frame and flexible sheet system of claim 8, wherein the engagement and rolling component comprises an engagement prong configured to extend through the bottom side of the top lineal track body via the track groove, and wherein the first top corner is configured to receive and securely latch the engagement prong such that the first top corner hangs from the engagement and rolling component.

10. The frame and flexible sheet system of claim 7, wherein the bottom lineal track body defines a track groove, wherein the track groove is on a top side of the bottom lineal track body, and wherein the bottom lineal track insert is configured to be received by the track groove and anchored in place via a screw to set the pivot axis of the articulating frame segment pair.

11. The frame and flexible sheet system of claim 10, wherein the bottom corner comprises a retractable bolt, and wherein the retractable bolt is configured to be received by the bottom lineal track insert to set the pivot axis.

12. The frame and flexible sheet system of claim 5, wherein the swinging frame segment is configured as a door.

13. (canceled)

14. (canceled)

15. A frame and flexible sheet system, comprising:
a. a top lineal track body with a reinforcing composite strip defining a wheel track and a top track groove;
b. a bottom lineal track body with a reinforcing composite strip defining a bottom track groove;
c. a first assembly component, comprising:
i. a first side, articulating frame segment pair; and
ii. a swinging frame segment; and
d. a second assembly component, comprising:
i. a second side, articulating frame segment pair;
wherein, each articulating frame segment pair comprises:
a first frame segment comprising:
three side bolt mechanisms each with a retractable bolt; and
an engagement mechanism for facilitating a pivot between the top lineal track body and the first frame segment; and
a second frame segment comprising:
a side bolt mechanism with a retractable bolt; and
a wheel track engagement mechanism for engaging the second frame segment to the wheel track of the top lineal track body; and
wherein, each bolt mechanism is configured to engage with the top track groove or the bottom track groove, via the retractable bolt,
e. a top weather-stripping lineal attached to the top lineal track body; and
f. a bottom weather-stripping lineal attached to each frame segment of the first assembly component and the second assembly component configured to engage with the bottom lineal track body.

16. (canceled)

17. (canceled)

18. The frame and flexible sheet system of claim 15, wherein two side bolt mechanisms of the three side bolt mechanisms of the first frame segment are configured to engage with the bottom track groove, via the retractable bolt.

19. The frame and flexible sheet system of claim 18, wherein one side bolt mechanism of the three side bolt mechanisms of the first frame segment are configured to engage with the top track groove, via the retractable bolt.

20. The frame and flexible sheet system of claim 15, wherein the side bolt mechanism of the second frame segment is configured to engage with the bottom track groove, via the retractable bolt.
